(19) United States
(12) Patent Application Publication
(10) Pub. No.: US 2025/0151649 A1
(43) Pub. Date: May 15, 2025

(54) SYSTEM AND METHOD FOR DETERMINING THE PASS WIDTH OF AN AGRICULTURAL HARVESTER

(71) Applicant: CNH Industrial America LLC, New Holland, PA (US)

(72) Inventor: Kevin Raymond Cordes, Glenmoore, PA (US)

(21) Appl. No.: 18/509,711

(22) Filed: Nov. 15, 2023

(51) Int. Cl. A01D 41/14; A01B 69/00; G05D 1/02

(52) U.S. Cl. CPC A01D 41/141; A01B 69/004

(57) ABSTRACT

A system for determining the pass width of an agricultural harvester includes a harvester including a base vehicle configured to support a harvesting implement configured to engage crop material during each pass across a field. The implement defines a cutting width extending between the first and second sides of the implement. Additionally, the system includes a computing system configured to control the operation of the harvester such that the harvester travels along the perimeter of the field. Furthermore, the computing system is configured to access an input indicative of the dimension of the perimeter and determine the dimension based on the accessed input. Moreover, the computing system is configured to determine the pass for the harvester to make each pass across the field based on the determined dimension of the perimeter. Additionally, the determined pass width is the same for each pass across the field.

### FIELD OF THE INVENTION

The present disclosure generally relates to agricultural harvesters and, more particularly, to systems and methods for determining the pass width of harvesting tool operating width for an agricultural harvester.

### BACKGROUND OF THE INVENTION

An agricultural harvester, such as a windrower, often includes a base vehicle, such as a self-propelled tractor or similar vehicle, and a harvesting implement, which is either towed or carried by the base vehicle. The harvesting implement, typically referred to as a header, is configured to cut/sever crop from a field and is supported on the harvester by forwardly projecting arms. Currently, a relatively wide swath of the crop is cut or severed and then consolidated into a narrower, substantially continuous windrow. This window is left to dry in the field until the moisture content has been reduced to a value suitable for subsequent harvesting operations, such as chopping or baling. However, current systems for controlling the operation of an agricultural harvester during such operation may result in windrows that dry at uneven rates.

Accordingly, a system and method for determining the pass width of an agricultural harvester would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to a system for determining the pass width of an agricultural harvester. The system includes an agricultural harvester including a base vehicle configured to support a harvesting implement configured to engage crop material during each pass across a field. The harvesting implement defines a cutting width extending between a first side and a second side of the harvesting implement perpendicular to a direction of travel. Additionally, the system includes a computing system. The computing system is configured to control an operation of the agricultural harvester such that the agricultural harvester travels along a perimeter of the field. Moreover, the computing system is configured to access an input indicative of a dimension of the perimeter of the field. Furthermore, the computing system is configured to determine the dimension of the perimeter of the field based on the accessed input. Additionally, the computing system is configured to determine a pass width, extending parallel to the cutting width, for the agricultural harvester to make each pass across the field based on the determined dimension of the perimeter of the field. Moreover, the determined pass width is the same for each pass across the field.

In another aspect, the present subject matter is directed to a method for determining the pass width of an agricultural harvester. The method includes controlling, with a computing system, an operation of an agricultural harvester to travel along a perimeter of a field. Additionally, the method includes accessing, with the computing system, an input indicative of a dimension of the perimeter of the field. Furthermore, the method includes determining, with the computing system, the dimension of the perimeter of the field based on the accessed input. Moreover, the method includes determining, with the computing system, a pass width for the agricultural harvester to make each pass across the field based on the determined dimension of the perimeter of the field, wherein the determined pass width is the same for each pass across the field. Additionally, the method includes controlling, with the computing system, the operation of the agricultural harvester based on the determined pass width.

In another aspect, the present subject matter is directed to an agricultural harvester. The agricultural harvester includes a frame and a pair of steerable wheels coupled to the frame and configured to move the agricultural harvester in a direction of travel. Additionally, the agricultural harvester includes a harvesting implement configured to engage crop material during each pass across a field. The harvesting implement defines a cutting width extending between a first side and a second side of the harvesting implement perpendicular to the direction of travel. Additionally, the agricultural harvester includes a merger assembly supported relative to the frame and configured to direct severed crop material away from the agricultural harvester. Furthermore, the agricultural harvester includes a computing system. The computing system is configured to control an operation of the agricultural harvester such that the agricultural harvester travels along a perimeter of the field. Moreover, the computing system is configured to access an input indicative of a dimension of the perimeter of the field. Furthermore, the computing system is configured to determine the dimension of the perimeter of the field based on the accessed input. Additionally, the computing system is configured to determine a pass width, extending parallel to the cutting width, for the agricultural harvester to make each pass across the field based on the determined dimension of the perimeter of the field. Moreover, the determined pass width is the same for each pass across the field.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a side view of one embodiment of an agricultural harvester in accordance with aspects of the present subject matter;

FIG. 2 illustrates a top view of the agricultural harvester illustrated in FIG. 1, particularly illustrating the harvester making a pass across a field;

FIG. 3 illustrates a schematic view of one embodiment of a system for determining the pass width of an agricultural harvester in accordance with aspects of the present subject matter;

FIG. 4 illustrates a flow diagram of one embodiment of control logic for determining the pass width of an agricultural harvester in accordance with aspects of the present subject matter; and

FIG. 5 illustrates a flow diagram of one embodiment of a method for determining the pass width of an agricultural harvester in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a system and a method for determining the pass width of an agricultural harvester. As will be described below, the agricultural harvester (e.g., a windrower) includes a base vehicle including a frame configured to support a harvesting implement. The harvesting implement defines a cutting width extending between first and second sides of the implement perpendicular to the direction of travel.

after determining the pass width, control the operation of the agricultural harvester such that at least a portion of the cutting width that is substantially equal to the determined pass width is used to engage the crop material when the agricultural harvester makes each pass across the field.

Additionally, a computing system of the disclosed system is configured to determine the pass width for the harvester to make each pass across the field to engage/harvest crop material. More specifically, the computing system is configured to control the operation of the harvester such that the harvester travels along the perimeter of the field. Then, the computing system is configured to access a first input, such as an input from a sensor or a field map, indicative of one or more dimensions of the perimeter of the field and determine the dimensions of the perimeter of the field, such as the width extending perpendicular to the direction of travel, based on the accessed first input. Thereafter, the computing system is configured to determine the pass width based on the determined dimensions of the perimeter of the field. The pass width determined by the computing system in which the harvester makes is the same/uniform for each and every pass across the field. Additionally, in some embodiments, the computing system may be configured to access a second input indicative of the cutting width defined by the harvesting implement and determine the pass width based on the accessed second input and the determined dimensions of the perimeter of the field. Thereafter, the computing system may be configured to control the operation of the harvester based on the determined pass width. For example, in some embodiments, the computing system is configured to control the operation of one or more actuators to steer a pair of steerable wheels of the harvester such that the harvester makes each pass across the field having an engagement pass width, which is substantially equal to the determined pass width.

Automatically determining a uniform/same pass width for the harvester to make each pass across the field improves the operation of the agricultural harvester. More specifically, for conventional systems, the entire cutting width of the harvesting implement is utilized during one or more passes of the field. Utilizing the entire cutting width may result in only a portion of the cutting width being utilized for some of the passes of the field. As such, the widths of the windrows of severed crop material may be inconsistent and, thus, dry at inconsistent rates. However, as described above, the disclosed system and method are directed to automatically determining the pass width for the harvester to make each pass across the field. Automatically determining uniform/equal pass widths, in turn, allows the harvester to be controlled such that all or a portion of the cutting width, substantially equal to the determined pass width, is utilized such that consistent widths of the windrows are severed from the field. This, in turn, results in consistent drying of severed crop material, as the severed crop material is uniformly dispersed.

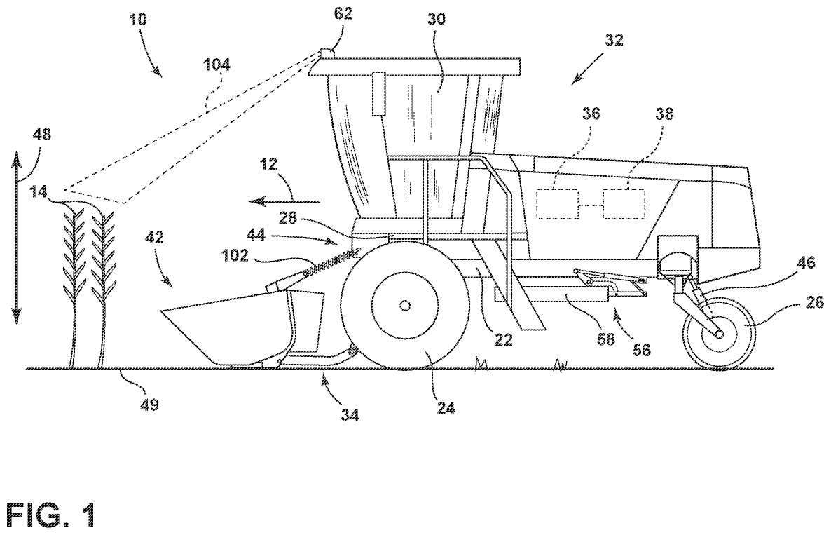

Referring now to the drawings, FIG. 1 illustrates a side view of one embodiment of an agricultural harvester 10 in accordance with aspects of the present subject matter. As shown in FIG. 1, the agricultural harvester 10 is configured as a self-propelled windrower. In general, the harvester 10 may be configured to travel across a field in a direction of travel (indicated by arrow 12) to harvest crop material 14 within a field. In this respect, the harvester 10 includes a base vehicle 32 configured to support a harvesting implement 34, such as a header, configured to engage the crop material 14 during a pass across the field. While traversing the field, the harvester 10 may be configured to discharge cut/severed crop material 14 away from the harvester 10. However, in alternative embodiments, the harvester 10 may have any other suitable harvester configuration.

As shown, the base vehicle 32 of the harvester 10 may include a chassis or main frame 22 configured to support and/or couple to various components of the harvester 10. For example, in several embodiments, the base vehicle 32 may include a pair of driven, front wheels 24 and a pair of steerable, rear wheels 26 coupled to the frame 22. As such, the wheels 24, 26 may be configured to support the harvester 10 relative to the ground and move the harvester 10 in the direction of travel 12. Moreover, one or more steering actuators 46 may be coupled between the pair of steerable, rear wheels 26 and the frame 22. As such, the steering actuator(s) 46 may be configured to steer the pair of rear wheels 26. Furthermore, the base vehicle 32 may include an operator's platform 28 having an operator's cab 30 that is supported by the frame 22. Furthermore, the base vehicle 32 may include an engine 36 and a transmission 38 mounted on the frame 22. The transmission 38 may be operably coupled to the engine 36 and may provide variably adjusted gear ratios for transferring engine power to the wheels 24 via a drive axle assembly (or via axles if multiple drive axles are employed).

Moreover, as shown in FIG. 1, the harvesting implement 34 extends forward of the frame 22 and is pivotably coupled thereto for generally vertical movement. As shown in FIG. 1, the harvesting implement 34 extends between a front end 42 and a rear end 44 pivotably coupled to a portion of the base vehicle 32. In this respect, the front end 42 of the harvesting implement 34, may be moved upward and downward along a vertical direction (indicated by arrow 48) relative to a field surface 49. As such, the harvester 10 may include one or more lift actuators 102 configured to adjust the height of the harvesting implement 34 relative to the field surface 49.

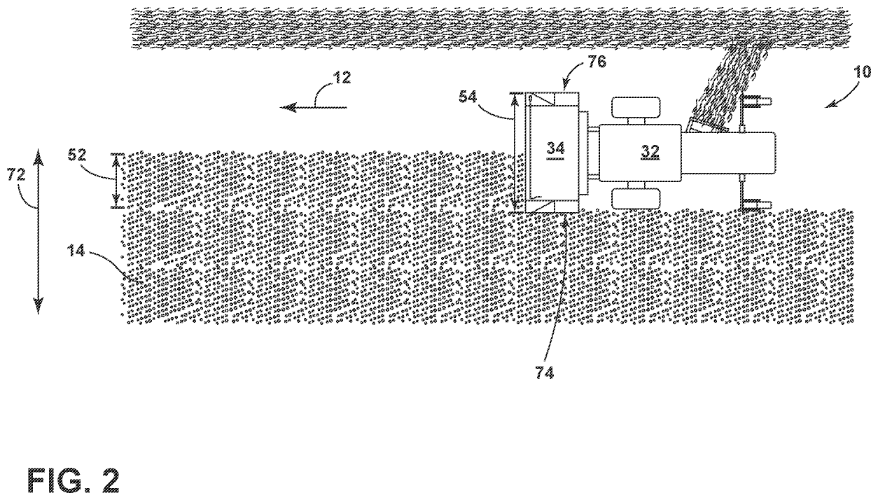

Referring now to FIG. 2, a top view of the harvester 10 illustrated in FIG. 1 is illustrated, particularly illustrating the harvester 10 making a pass across a field. As shown in FIG. 2, the harvesting implement 34 extends in a lateral direction (indicated by arrow 72) perpendicular to the direction of travel 12 between a first side 74 and a second side 76. The harvesting implement 34 defines a cutting width (indicated by arrow 54) extending between the first side 74 and the second side 76 of the harvesting implement 34 in the lateral direction 72. The cutting width 54 may correspond to a maximum width at which the harvesting implement 34 severs the crop material 14 from the field. As the harvester 10 is propelled in the direction of travel 12 to make passes across the field, the harvesting implement 34 may sever the crop material 14 from the field at the cutting width 54 or a portion of the cutting width 54. As such, the harvesting implement 34 includes a sickle-bar, rotary cutter, or any other suitable cutting mechanism supported thereon for severing the crop material 14 from the field.

During operations, the harvester 10 may utilize a pass width (as indicated by arrow 52) for the harvester 10 to make each pass across the field. As shown in FIG. 2, the pass width 52 extends parallel to the cutting width 54 and, as will be described below, may be determined by one or more computing systems. The determined pass width 52 is uniform/the same for each pass that the harvester 10 makes across the field. Furthermore, the determined pass width 52 is substantially equal to the cutting width 54 or the portion of the cutting width 54 that is utilized by the harvester 10 to engage/sever the crop material 14 during each pass across the field. For example, the portion of the cutting width 54 utilized by the harvester 10 may be between 0 and 6 inches different (e.g., greater than or less than) than the determined pass width 52, such as 2 and 4 inches.

Referring back to FIG. 1, the base vehicle 32 of the harvester 10 may also include a merger assembly 56 supported under the frame 22 at a location aft of the harvesting implement 34. In general, the merger assembly 56 may include a merger frame 58 configured to support an endless loop-style conveyer (not shown) for directing the severed crop material 14 discharged from the harvesting implement 34 to a location transversely displaced from a longitudinal centerline of the harvester 10 (e.g., by directing the crop material 14 to one side of the harvester 10). In this manner, windrows of harvested crop material 14 may be positioned for combination (i.e., merging) with the harvested crop material 14 from a previous pass made by the harvester 10.

It should be further appreciated that the configuration of the agricultural harvester 10 described above and shown in FIGS. 1 and 2 is provided only to place the present subject matter in an exemplary field of use. Thus, it should be appreciated that the present subject matter may be readily adaptable to any manner of agricultural harvester and/or harvesting implement configuration.

Furthermore, the harvester 10 may include one or more sensors 62 coupled thereto and/or supported thereon. The sensor(s) 62 is configured to generate data indicative of one or more dimensions of a perimeter or boundary of the field. For example, in one embodiment, the data may be indicative of the width of the field extending perpendicular to the direction of travel 12 in the lateral direction 72. As will be described below, such data may subsequently be used to determine the dimension(s) of the perimeter, such as the width, of the field.

In general, the sensor(s) 62 may correspond to any suitable sensor(s) configured to generate data indicative the dimension(s) of the perimeter of the field. In several embodiments, the sensor(s) 62 may be configured as an imaging device(s), such as a light detection and ranging (LiDAR), camera(s), and/or the like configured to depict a portion of the field within a field(s) of view 104 of the sensor(s) 62.

In alternative embodiments, the sensor(s) 62 may be configured as any other suitable sensor(s) for generating data indicative of the dimension(s) of the perimeter of the field. For example, the sensor(s) 62 may be configured as a location sensor(s), such as a global positioning system(s) (GPS) or other GNSS-based sensor(s). As such, the sensor(s) 62 may track a position of the harvester 10 as the harvester 10 travels around the perimeter of the field and, thus, generate data indicative of the dimension(s) of the perimeter of the field.

Furthermore, the harvester 10 may include any number of sensors 62 provided at any suitable location that allows data indicative of the dimension(s) of the perimeter of the field to be generated. In this respect, FIG. 1 illustrates an example location for mounting the sensor(s) 62 for generating data indicative of the dimension(s) of the perimeter of the field. For example, in embodiments in which the sensor(s) 62 is configured as an imaging device(s), the sensor(s) 62 may be mounted on the operator's cab 30 of the base vehicle 32 of the harvester 10 such that the sensor(s) 62 has the field(s) of view 104 directed forward of the of the harvester 10. However, in alternative embodiments, the sensor(s) 62 may be installed at any other suitable location(s) that allows the device(s) to generate data indicative of the dimension(s) of the perimeter of the field.

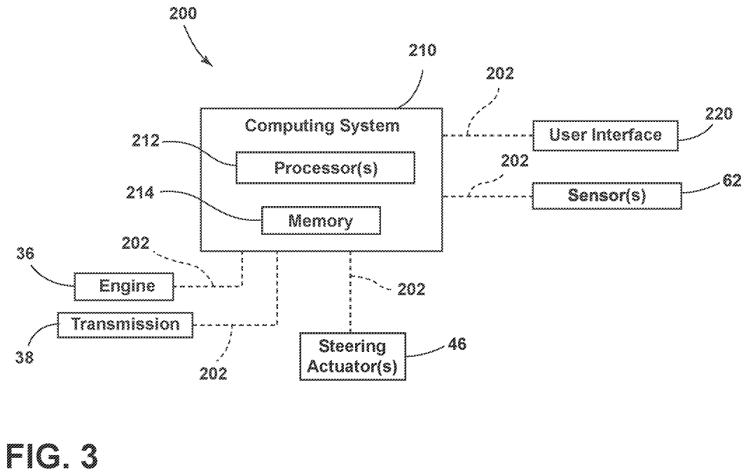

Referring now to FIG. 3, a schematic view of one embodiment of a system 200 for determining the pass width of an agricultural harvester is illustrated in accordance with aspects of the present subject matter. In general, the system 200 will be described herein with reference to the agricultural harvester 10 described above with reference to FIGS. 1-2. However, it should be appreciated that the disclosed system 200 may generally be utilized with agricultural harvesters having any suitable harvester configuration.

As shown in FIG. 3, the system 200 includes a computing system 210 communicatively coupled to one or more components of the harvester 10 and/or the system 200 to allow the operation of such components to be electronically or automatically controlled by the computing system 210. For instance, the computing system 210 may be communicatively coupled to the sensor(s) 62 via a communicative link 202. As such, the computing system 210 may be configured to receive data from the sensor(s) 62 indicative of the dimension(s) of the perimeter of the field. Moreover, the computing system 210 may be communicatively coupled to the steering actuator(s) 46. As such, the computing system 210 may be configured to control the operation of the steering actuator(s) 46 to steer the steerable wheels 26 such that at least the portion of the cutting width 54 that is substantially equal to the determined pass width 52 is used to engage the crop material when the harvester 10 makes each pass across the field. Furthermore, the computing system 210 may be communicatively coupled to the engine 36 and/or the transmission 38 of the base vehicle 32 of the harvester 10 via the communicative link 202. In this respect, the computing system 210 may be configured to control the operation of the engine 36 and/or the transmission 38 to adjust and/or halt the ground speed at which the harvester 10 travels across the field. In addition, the computing system 210 may be communicatively coupled to any other suitable components of the harvester 10 and/or the system 200.

In general, the computing system 210 may comprise any suitable processor-based device known in the art, such as a given controller or computing device or any suitable combination of controllers or computing devices. Thus, in several embodiments, the computing system 210 may include one or more processor(s) 212 and associated memory device(s) 214 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 214 of the computing system 210 may generally comprise memory element(s) including, but not limited to, a computer readable medium (e.g., random access memory (RAM)), a computer readable non-volatile medium (e.g., a flash memory), a floppy disc, a compact disc-read only memory (CD-ROM), a magneto-optical disc (MOD), a digital versatile disc (DVD), and/or other suitable memory elements. Such memory device(s) 214 may generally be configured to store suitable computer-readable instructions that, when implemented by the processor(s) 212, configure the computing system 210 to perform various computer-implemented functions, such as one or more aspects of the methods and algorithms that will be described herein. In addition, the computing system 210 may also include various other suitable components, such as a communications circuit or module, one or more input/output channels, a data/control bus and/or the like.

It should be appreciated that the computing system 210 may correspond to an existing computing system(s) of the agricultural harvester 10, itself, or the computing system 210 may correspond to a separate processing device. For instance, in one embodiment, the computing system 210 may form all or part of a separate plug-in module that may be installed in association with the agricultural harvester 10 to allow for the disclosed systems to be implemented without requiring additional software to be uploaded onto existing control devices of the agricultural harvester 10.

Furthermore, it should also be appreciated that the functions of the computing system 210 may be performed by a single processor-based device or may be distributed across any number of processor-based devices, in which instance such devices may be considered to form part of the computing system 210. For instance, the functions of the computing system 210 may be distributed across multiple application-specific controllers or computing devices, such as a navigation controller, an engine computing controller, a transmission controller, an implement controller and/or the like.

In addition, the system 200 may also include a user interface 220. More specifically, the user interface 220 may be configured to provide feedback, such as feedback associated with the determined pass width 52 and/or the dimension(s) of the perimeter of the field, to the operator. As such, the user interface 220 may include one or more feedback devices (not shown), such as display screens, speakers, warning lights, and/or the like, which are configured to provide feedback from the computing system 210 to the operator. As such, the user interface 220 may, in turn, be communicatively coupled to the computing system 210 via the communicative link 202 to permit the feedback to be transmitted from the computing system 210 to the user interface 220. Furthermore, some embodiments of the user interface 220 may include one or more input devices, such as touchscreens, keypads, touchpads, knobs, buttons, sliders, switches, mice, microphones, and/or the like, which are configured to receive inputs from the operator. For example, the input device(s) may be configured to access an input indicative of the cutting width 54 from the operator. Furthermore, in one embodiment, the user interface 220 may be mounted or otherwise positioned within the operator's cab 30 of the base vehicle 32 of the agricultural harvester 10. However, in alternative embodiments, the user interface 220 may mounted at any other suitable location.

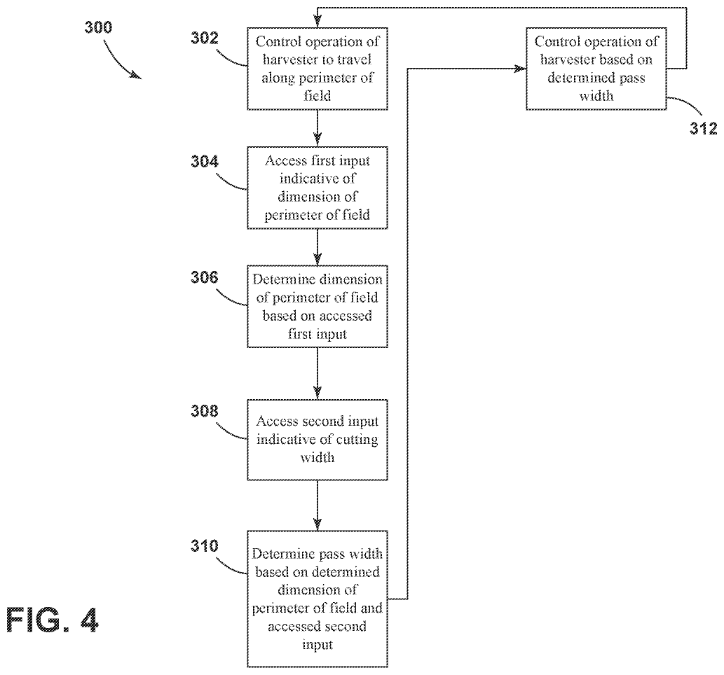

Referring now to FIG. 4, a flow diagram of one embodiment of control logic 300 that may be executed by the computing system 210 (or any other suitable computing system) for determining the pass width of an agricultural harvester is illustrated in accordance with aspects of the present subject matter. Specifically, the control logic 300 shown in FIG. 4 is representative of steps of one embodiment of an algorithm that can be executed to determine the pass width of the agricultural harvester 10 such that the agricultural harvester 10 can be controlled so at least a portion of the cutting width substantially equal to the determined pass width is used during each pass across the field. Thus, in several embodiments, the control logic 300 may be advantageously utilized in association with a system installed on or forming part of an agricultural harvester to allow for real-time determination of the pass width without requiring substantial computing resources and/or processing time. However, in other embodiments, the control logic 300 may be used in association with any other suitable system, application, and/or the like for determining the pass width.

As shown in FIG. 4, at (302), the control logic 300 includes controlling the operation of an agricultural harvester such that the agricultural harvester travels along the perimeter of the field. Specifically, as mentioned above, in several embodiments, the computing system 210 may be communicatively coupled to the engine 36, the transmission 38, and/or the steering actuator(s) 46 of the base vehicle 32 of the harvester 10 via the communicative link 202. In this respect, the computing system 210 may be configured to transmit instructions to the engine 36 and/or the transmission 38 instructing the engine 36 and/or the transmission 38 to adjust their operation such that the harvester 10 travels along the perimeter of the field. For example, the computing system 210 may instruct the engine 36 to vary its power output and/or the transmission 38 to upshift or downshift to increase or decrease the ground speed and/or stop/halt movement of the harvester 10. Additionally, or alternatively, the computing system 210 may control the operation of the steering actuator(s) 46 to steer the wheels 26 such that the harvester 10 travels along the perimeter of the field. However, in alternative embodiments, the computing system 210 may be configured to transmit instructions to any other suitable components (e.g., braking actuators) of the harvester 10 such that the harvester 10 travels along the perimeter of the field.

Moreover, at (304), the control logic 300 includes accessing a first input indicative of a dimension of the perimeter of the field. Specifically, as mentioned above, in several embodiments, the computing system 210 may be communicatively coupled to the sensor(s) 62 via the communicative link 202. In this respect, as the harvester 10 travels along the perimeter of the field, the computing system 210 may receive the data from the sensor(s) 62 via the communicative link 202. Such data, in turn, is indicative of the dimension, such as the width extending perpendicular to the direction of travel 12, of the perimeter of the field.

In several embodiments, when the sensor(s) 62 is configured as the imaging device(s) (e.g., LiDAR), the computing system 210 may be configured to receive the data from the imaging device(s) depicting the portion of the field within the field(s) of view 104 of the imaging device(s).

Additionally, or alternatively, in several embodiments, when the sensor(s) 62 is configured as the location sensor(s) (e.g., GNSS-based sensor(s)), the computing system 210 may be configured to receive the data indicative of the dimension(s) of the perimeter of the field from the location sensor(s), which may track the position of the harvester 10 as the harvester 10 traveled through the field to generate the data.

Alternatively, in several embodiments, the computing system 210 may be configured to access a field map. In general, the field map may be stored within the memory device(s) 214 of the computing system 210 and/or in a remote database server (not shown) and include geo-referenced data that is indicative of the dimensions of the perimeter of the field. For example, the geo-referenced data used to create the field map may be collected during a previously performed agricultural operation (e.g., a field scouting operation with an unmanned aerial vehicle (UAV) or drone, a harvesting operation, and/or the like). In this respect, as the harvester 10 travels along the perimeter of the field, the computing system 210 may access the field map from its memory device(s) 214. The field map may, in turn, depict the dimensions, such as the width extending perpendicular to the direction of travel 12, of the perimeter of the field.

Additionally, at (306), the control logic 300 includes determining the dimension of the perimeter of the field based on the accessed first input. In this respect, in several embodiments, the computing system 210 may be configured to determine one or more dimensions of the perimeter of the field based on the first input accessed at (304). For example, in some embodiments, the computing system 210 may be configured to determine the width of the field extending perpendicular to the direction of travel 12 based on the first input received at (304). However, in other embodiments, the computing system 210 may be configured to determine any suitable dimension of the field.

Furthermore, at (308), the control logic 300 includes accessing a second input indicative of the cutting width. Specifically, as mentioned above, in several embodiments, the computing system 210 may be communicatively coupled to the user interface 220 via the communicative link 202. In this respect, the computing system 210 may access the second input from the operator of the harvester 10 of the cutting width 54 defined by the harvesting implement 34. However, it should be appreciated that the computing system 210 may access the second input in any other suitable manner, such as accessing an input stored within the memory device(s) 214.

Moreover, as shown in FIG. 4, at (310), the control logic 300 includes determining a pass width, extending parallel to the cutting width, for the agricultural harvester to make each pass across the field based on the determined dimension of the perimeter of the field and the accessed second input, wherein the determined pass width is the same for each pass across the field. For example, in several embodiments, the computing system 210 may be configured to determine the pass width 52 based on the accessed second input at (308) and the dimension, such as the width extending perpendicular to the direction of travel 12, of the field determined at (306) such that the determined pass width 52 is uniform/the same for each pass across the field. In this respect, in some embodiments, the computing system 210 may access a look-up table, equations, and/or the like stored within its memory device(s) 214 that correlates the accessed second input at (308) and the dimension of the field determined at (306) to the corresponding pass width 52 such that the determined pass width 52 is uniform/the same for each pass across the field.

Automatically determining the pass width 52 such that the determined pass width 52 is uniform/the same for each pass that the harvester 10 makes across the field allows the harvester 10 to be controlled such that all or a portion of the cutting width 54 is utilized such that consistent widths of windrows of crop material 14 are severed from the field. This, in turn, results in consistent drying of the severed crop material 14, as the severed crop material 14 is uniformly dispersed.

Additionally, at (312), the control logic 300 includes controlling the operation of the agricultural harvester based on the determined pass width. Specifically, in one embodiment, the computing system 210 may be configured to control the operation of the harvester 10 such that at least the portion of the cutting width 54 that is substantially equal to the pass width 52 determined at (310) is used to engage the crop material 14 while the harvester 10 makes each pass across the field. For example, the computing system 210 may be configured to control an operation of the steering actuator(s) 46 to steer the wheels 26 of the base vehicle 32 of the harvester 10 such that the portion of the cutting width 54 that is substantially equal to the pass width 52 determined at (310) is used to engage the crop material 14 for each and every pass that the harvester 10 makes across the field. As such, consistent widths of windrows of crop material 14 are severed from the field.

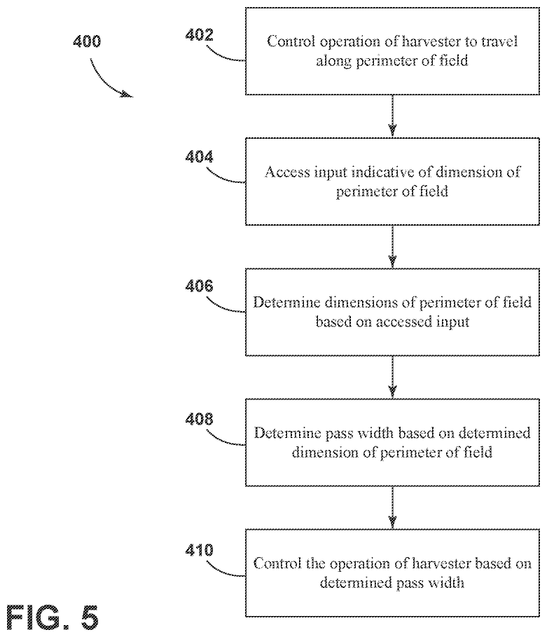

Referring now to FIG. 5, a flow diagram of one embodiment of a method 400 for determining the pass width of an agricultural harvester is illustrated in accordance with aspects of the present subject matter. In general, the method 400 will be described herein with reference to the agricultural harvester 10 shown in FIGS. 1 and 2 and the system 200 described with reference to FIGS. 3 and 4. However, it should be appreciated that the disclosed method 400 may be implemented with agricultural harvesters and/or harvesting implements having any other suitable configurations and/or within systems having any other suitable system configuration. In addition, although FIG. 5 depicts steps performed in a particular order for purposes of illustration and discussion, the methods discussed herein are not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

As shown in FIG. 5, at (402), the method 400 may include controlling an operation of an agricultural harvester to travel along a perimeter of a field. For instance, as indicated above, in several embodiments, the computing system 210 may be configured to control the operation of the harvester 10 to travel along the perimeter of the field.

Furthermore, at (404), the method 400 may include accessing an input indicative of a dimension of the perimeter of the field. For instance, as indicated above, in several embodiments, the computing system 210 may be configured to access the input, such as the sensor data or the field map, indicative of the dimension of the perimeter of the field.

Additionally, at (406), the method 400 may include determining the dimension of the perimeter of the field based on the accessed input. For instance, as indicated above, in several embodiments, the computing system 210 may be configured to determine the dimension (e.g., width) of the perimeter of the field based on the accessed input, such as the sensor data or the field map.

Moreover, at (408), the method 400 may include determining a pass width for the agricultural harvester to make each pass across the field based on the determined dimension of the perimeter of the field. For instance, as indicated above, the computing system 210 may be configured to determine the pass width based on the determined dimension (e.g., width) of the perimeter of the field.

Furthermore, at (410), the method 400 may include controlling the operation of the agricultural harvester based on the determined pass width. For instance, as indicated above, the computing system 210 may be configured to control the operation of the harvester 10 based on the determined pass width.

It is to be understood that the steps of the control logic 300 and the method 400 are performed by the computing system 210 upon loading and executing software code or instructions which are tangibly stored on one or more tangible computer readable media, such as one or more magnetic media (e.g., a computer hard drive(s)), one or more optical media (e.g., an optical disc(s)), solid-state memory (e.g., flash memory), and/or other storage media known in the art. Thus, any of the functionality performed by the computing system 210 described herein, such as the control logic 300 and the method 400, is implemented in software code or instructions which are tangibly stored on one or more tangible computer readable media. The computing system 210 loads the software code or instructions via a direct interface with the one or more computer readable media or via a wired and/or wireless network. Upon loading and executing such software code or instructions by the computing system 210, the computing system 210 may perform any of the functionality of the computing system 210 described herein, including any steps of the control logic 300 and the method 400 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A system for determining the pass width of an agricultural harvester, the system comprising:
an agricultural harvester including a base vehicle configured to support a harvesting implement configured to engage crop material during each pass across a field, the harvesting implement defining a cutting width extending between a first side and a second side of the harvesting implement perpendicular to a direction of travel; and
a computing system configured to:
control an operation of the agricultural harvester such that the agricultural harvester travels along a perimeter the field;
access an input indicative of a dimension of the perimeter of the field;
determine the dimension of the perimeter of the field based on the accessed input; and
determine a pass width, extending parallel to the cutting width, for the agricultural harvester to make each pass across the field based on the determined dimension of the perimeter of the field, wherein the determined pass width is the same for each pass across the field.

2. The system of claim 1, wherein the accessed input corresponds to an accessed first input, the computing system further configured to:
access a second input indicative of the cutting width; and
determine the pass width based on the accessed second input and the determined dimension of the perimeter of the field.

3. The system of claim 2, wherein the computing system is further configured to:
determine a width of the field, extending perpendicular to the direction of travel, based on the accessed first input; and
determine the pass width based on the determined width of the field and the accessed second input.

4. The system of claim 1, further comprising:
a sensor configured to generate data indicative of the dimension of the perimeter of the field, and
wherein, when determining the dimension of the perimeter of the field based on the accessed input, the computing system is further configured to:
determine the dimension of the perimeter of the field based on the data generated by the sensor.

5. The system of claim 4, wherein the sensor is configured as an imaging device.

6. The system of claim 4, wherein the sensor is configured as a location sensor.

7. The system of claim 1, wherein:
when accessing the input indicative of the dimension of the perimeter of the field, the computing system is configured to access a field map depicting the dimension of the perimeter of the field; and
when determining the dimension of the perimeter of the field based on the accessed input, the computing system is configured to determine the dimension of the perimeter of the field based on the accessed field map.

8. The system of claim 1, wherein the computing system is further configured to:
after determining the pass width, control the operation of the agricultural harvester such that at least a portion of the cutting width that is substantially equal to the determined pass width is used to engage the crop material while the agricultural harvester makes each pass across the field.

9. The system of claim 1, wherein the agricultural harvester is configured as an agricultural windrower.

10. A method for determining the pass width of an agricultural harvester, the method comprising:
controlling, with a computing system, an operation of an agricultural harvester to travel along a perimeter of a field;
accessing, with the computing system, an input indicative of a dimension of the perimeter of the field;
determining, with the computing system, the dimension of the perimeter of the field based on the accessed input;
determining, with the computing system, a pass width for the agricultural harvester to make each pass across the field based on the determined dimension of the perimeter of the field, wherein the determined pass width is the same for each pass across the field; and
controlling, with the computing system, the operation of the agricultural harvester based on the determined pass width.

11. The method of claim 10, wherein the accessed input corresponds to an accessed first input, the method further comprising:
accessing, with the computing system, a second input indicative of a cutting width defined by the harvesting implement perpendicular to a direction of travel; and
determining, with the computing system, the pass width based on the accessed second input and the determined dimension of the perimeter of the field.

12. The method of claim 11, further comprising:
determining, with the computing system, a width of the field, extending perpendicular to the direction of travel, based on the accessed first input; and
determining, with the computing system, the pass width based on the determined width of the field and the accessed second input.

13. The method of claim 10, wherein:
when accessing the input indicative of the dimension of the field, the method includes receiving, with the computing system, sensor data indicative of the dimension of the perimeter of the field; and
when determining the dimension of the perimeter of the field based on the accessed input, the method includes determining, with the computing system, the dimension of the perimeter of the field based on the received sensor data.

14. The method of claim 10, wherein:
when accessing the input indicative of the dimension of the perimeter of the field, the method includes accessing, with the computing system, a field map depicting the dimension of the perimeter of the field; and
when determining the dimension of the perimeter of the field based on the accessed input, the method includes determining, with the computing system, the dimension of the perimeter of the field based on the accessed field map.

15. The method of claim 10, wherein, after determining the pass width, the method further comprises:
controlling, with the computing system, the operation of the agricultural harvester such that at least a portion of a cutting width, defined by an agricultural implement supported by a base vehicle of the agricultural harvester, that is substantially equal to the determined pass width is used to engage crop material while the agricultural harvester makes each pass across the field.

16. An agricultural harvester, comprising:
a frame;
a pair of steerable wheels coupled to the frame and configured to move the agricultural harvester in a direction of travel;
a harvesting implement configured to engage crop material during each pass across a field, the harvesting implement defining a cutting width extending between a first side and a second side of the harvesting implement perpendicular to the direction of travel;
a merger assembly supported relative to the frame and configured to direct severed crop material away from the agricultural harvester; and
a computing system configured to:
control an operation of the agricultural harvester such that the agricultural harvester travels along a perimeter of the field;
access an input indicative of a dimension of the perimeter of the field;
determine the dimension of the perimeter of the field based on the accessed input; and
determine a pass width, extending parallel to the cutting width, for the agricultural harvester to make each pass across the field based on the determined dimension of the perimeter of the field, wherein the determined pass width is the same for each pass across the field.

17. The agricultural harvester of claim 16, further comprising:
a sensor configured to generate data indicative of the dimension of the perimeter of the field, and
wherein, when determining the dimension of the perimeter of the field based on the accessed input, the computing system is further configured to:
determine the dimension of the perimeter of the field based on the data generated by the sensor.

18. The agricultural harvester of claim 16, further comprising:
an actuator coupled between the pair of steerable wheels and the frame, the actuator configured to steer the steerable wheels, and
wherein, the computing system is further configured to:
control an operation of the actuator to steer the steerable wheels such that at least a portion of the cutting width that is substantially equal to the determined pass width is used to engage the crop material when the agricultural harvester makes each pass across the field.
